(19) United States
(12) Patent Application Publication
(10) Pub. No.: US 2008/0076580 A1
(43) Pub. Date: Mar. 27, 2008

(54) Smart internet sports apparatus with multiple wireless protocols

(76) Inventors: Wilbert Q. Murdock, Bronx, NY (US); Philip A. Williams, Salt Point, NY (US)

Correspondence Address: Wilbert Murdock, 1118 E 215th St, Bronx, NY, 10469, US

(21) Appl. No.: 11/901,553

(22) Filed: Sep. 18, 2007

Related U.S. Application Data
(63) Continuation-in-part of application No. 09/570,233, filed on May 12, 2000.

(51) Int. Cl. G06F 17/00

(52) U.S. Cl. 463/42

(57) ABSTRACT

A Smart Internet Sports Apparatus protocol which can communicate with the Internet allowing a plurality of data to be captured processed and analyzed. Each Internet sports apparatus device creates it own proprietary unique data profile, and can exchange its profile with another Internet sports apparatus protocol or other proprietary digital devices. The Internet sports apparatus protocol automatically allows as many participants including those in sports to adjust to the number of active players who have been granted permission to join. The original system design talked about using radio frequency protocol and left open the door for other wireless protocols. Now with this new invention, other wireless protocols can be used as a communication bridge allowing a broader use of the technologies. The Smart Internet Sports Apparatus protocols now used Zigbee, Bluetooth, Wi-Fi, Wi-Max, and Ultra Wide Band (UWB). Future uses can expand to cellular protocol. Using GPS the Smart sports apparatus protocols with embedded single and multiplayer software is said sports apparatus, can now be tracked to a specific location. The invention employs GPS to distinguish on Smart sports apparatus device from another. The invention also allows the interchanging of specific wireless protocols in a custom sports apparatus device with an open bay to receive this modular insert.

### BACKGROUND OF INVENTION

This invention relates to providing a new standard for Internet communications that can be used for game play, interactive sports competition, and general communications. Thus far most inventions that involved game play and competition, using client-server has been limited to the virtual space. By introducing our new Internet communications protocols, gamers, sports enthusiasts, can now use an external sports apparatus they can hold in their hand from their favorite sport such as golf, tennis, soccer, baseball, etc with embedded sensors and attached sensors to gauge their swing and body performance against themselves and opponents in remote locations. Recent history has shown that the evolution of the games market specifically is not dependent on the fastest processor with the best graphics. People want to be in the game and not outside of it. Our invention of combining Smart sports apparatus devices, with wireless protocols, with Internet connectivity, brings the real elements of game play and competition to the forefront that goes way beyond the virtual space, and now becomes the real space of play. Our inventions approach is to use graphics as a training and educational tool, that integrated in the background of the system, whereby these same graphics and sound feedback creates an exact and precise learning path. Motion and swing results are posted on the server from the client. These data is always available on the server, and can be exchanged with other Smart sports apparatus users. The invention allows this new sports apparatus device to be tracked in real-time, providing a more robust set of additional data to build a more complete players profile. The invention allows players to play locally using wireless protocols such as Zigbee, Bluetooth and Radio Frequency that allow local game play and some players can play remotely using other wireless protocols such as Wi-Fi, Wi-Max, UWB and Cellular. The invention also allows the user to choose a specific wireless protocol device and plug it into our Smart sports apparatus device with an open bay to receive the modular plug-in electronics. The invention allows complete intuitive play based on ease of use, and virtually zero learning curve. It does the complete analysis for all users.

### BRIEF DESCRIPTION OF THE FIGURES

FIG. 1 is a simple flowchart of the SMART INTERNET SPORTS APPARATUS WITH MULTIPLE WIRELESS PROTOCOLS

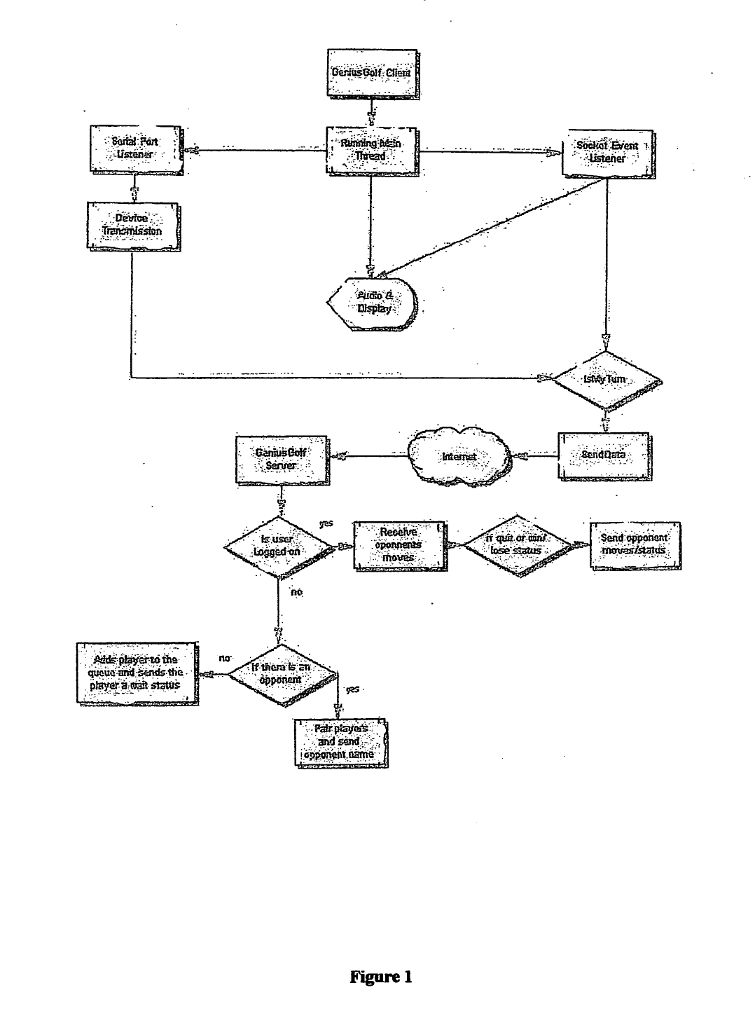

FIG. 2 is another simple flowchart of the SMART INTERNET SPORTS APPARATUS WITH MULTIPLE WIRELESS PROTOCOLS

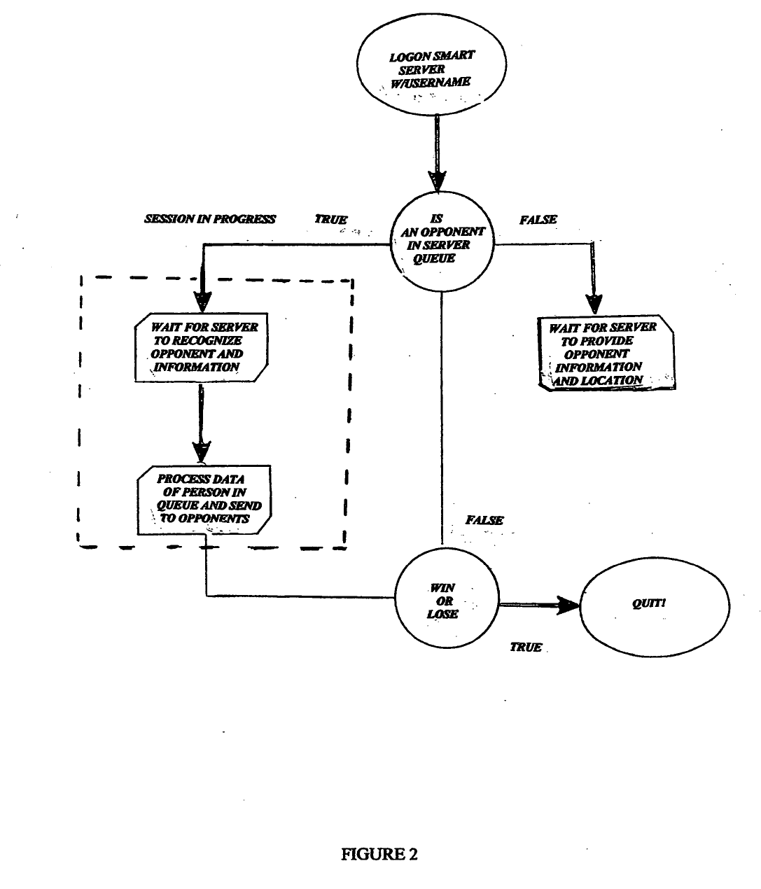

FIG. 3 is What's Inside the Smart Golf Club Apparatus

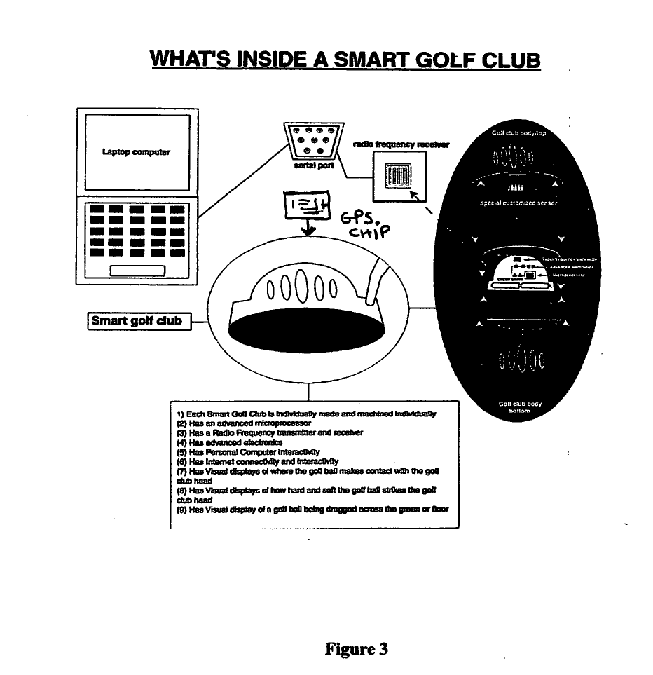

FIG. 4 is Smart Golf Club vs Dumb Golf Club

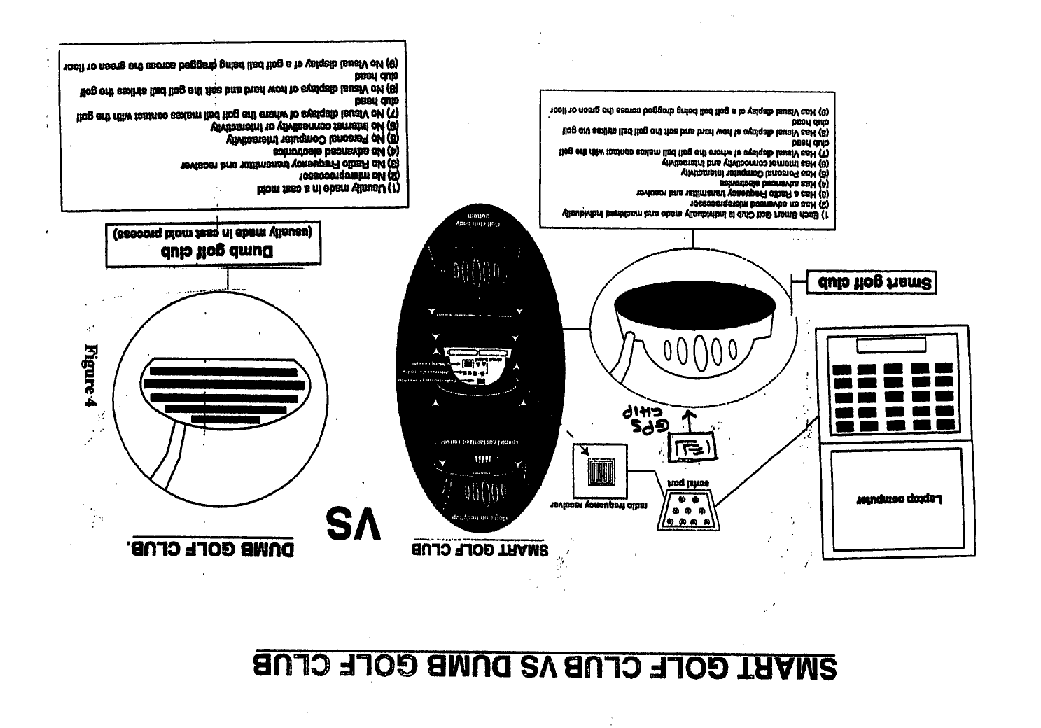

FIG. 5 is Smart Golf Connected to the Internet

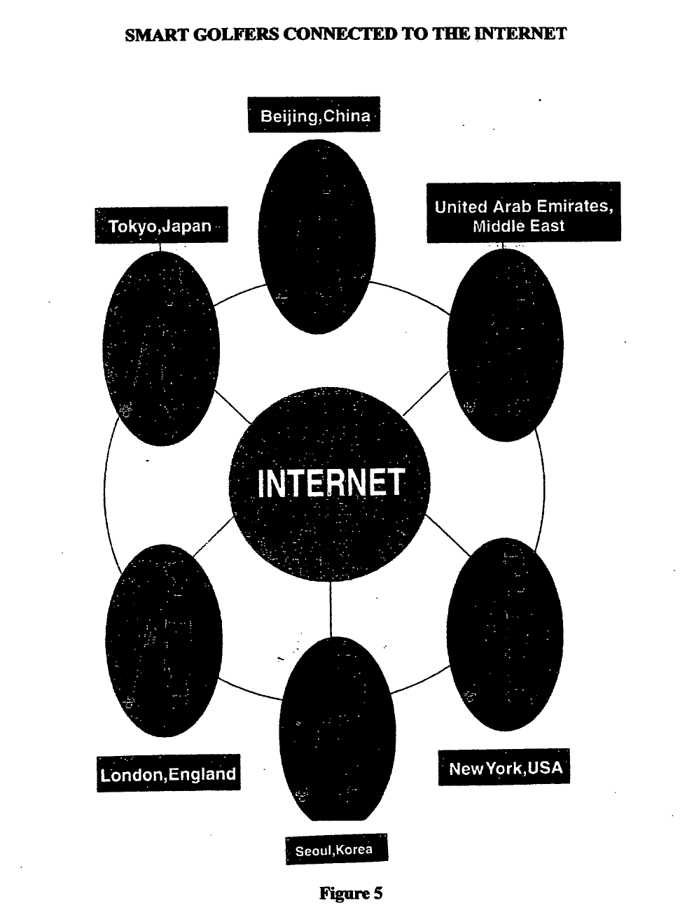

FIG. 6 is Smart Sports Devices

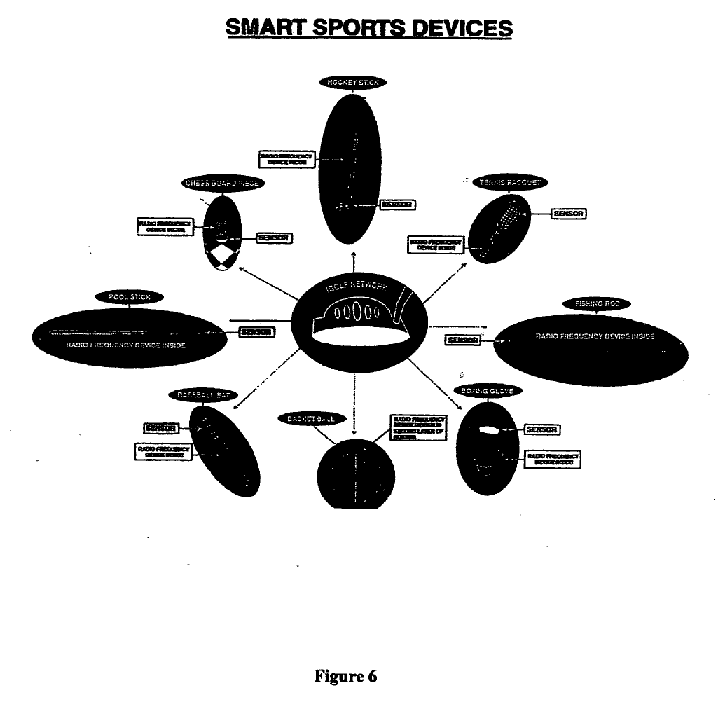

FIG. 7 is Smart Cellphone Connection

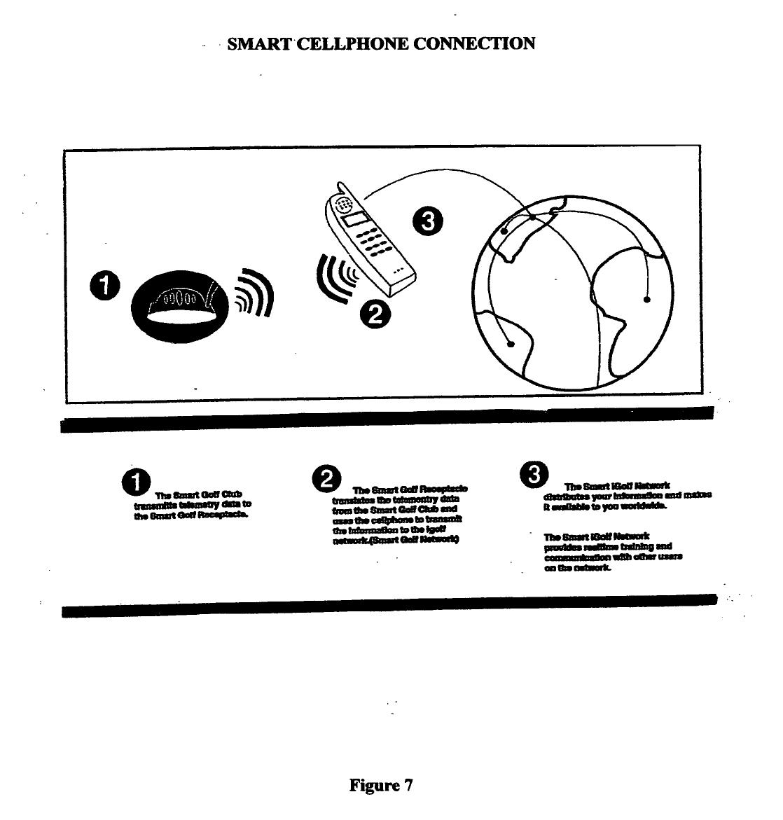

FIG. 8 is Smart PDA Connection

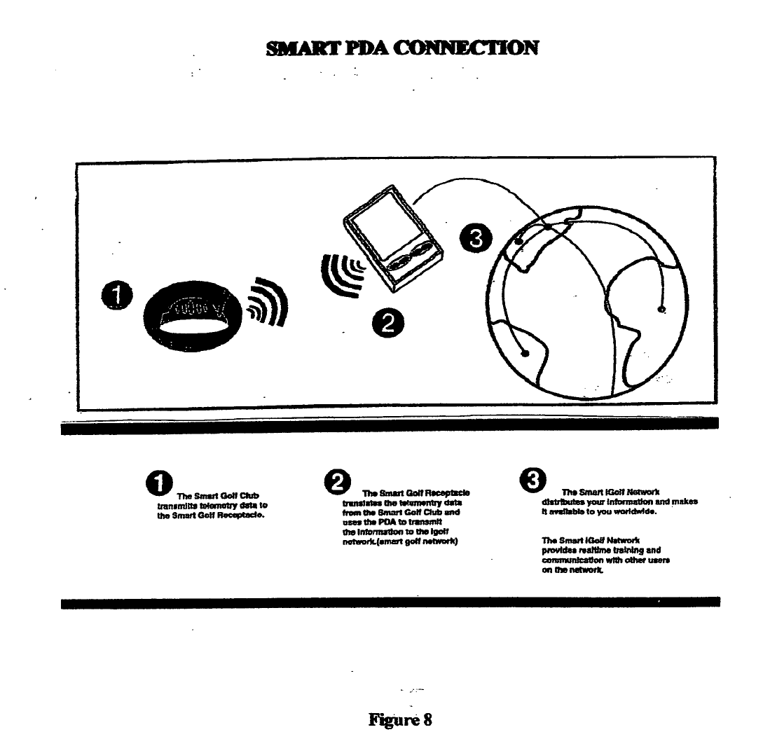

What is claimed is:

1: An apparatus for communication means for a plurality of local devices and sensors, and remote devices and sensors, with said apparatus comprising:
a first computer programmed to process data derived from data acquired by said local and remote devices and sensors;
a second computer programmed to communicate with one or more said remote first computers;
a first communications link for transmitting data derived from said data acquired by said first local sensors and devices to said first computer;
a second communications link or medium for transmitting data derived from said data acquired by said first computers to said second computer;
wherein said first computer is programmed to analyze the performance data of a person in an activity that involves swinging and or body motion; and
said first computer is programmed to analyze data obtained from a sporting device or activity apparatus; and
wherein said second computer comprises a sports competition server and is programmed to communicate via the Internet, GPS, and Cellular to a plurality of first computers; and
wherein said first communications link is comprised of any of a variety of various communications media such an RF, Bluetooth, and WiFi connection; and
wherein said second communications link is comprised of any of a plurality of communication mediums such as the Internet, GPS, and Cellular connections.

2: The apparatus as recited in claim 1, wherein said first computer is further programmed to send the results of said performance analysis to said second computer upon completion of said performance analysis.

3: The apparatus as recited in claim 1, further comprising a sports competition server connected to said first computer via a network and said second communications link; wherein said second computer comprises said sports competition server and said first computer is further programmed to process data from said sports competition server representing the performance of a competitor at a remote site during the turn of said competitor.

4: The apparatus as recited in claim 3, wherein said first computer is further programmed to send the results of said performance analysis to said sports competition server upon completion of said performance analysis via said second communications link.

5: The apparatus as recited in claim 2, wherein said first computer programming comprises:
a serial port listener program that receives acquired data from said apparatus;
a socket event listener that receives data from said sports competition server;
and a main thread for alternately processing data received by either said socket event listener or said serial port listener in accordance with a sports competition format wherein acquired data from each said apparatus are processed by said computer and the processing results are sent to said sports competition server only if data has been previously received from said sports competition server indicating that it is that player's turn to play, and acquired data from said apparatus are ignored by said first computer and said sports competition server if data has been previously received from said sports competition server indicating that it is not that player's turn to play;
wherein, sequential play is achieved by allowing the reception of data only from the remote apparatus of the player whose turn it is to play thus allowing for the use of one or more said apparatus or sports devices, with one or more said first computers in the network.

6: The apparatus as recited in claim 1, wherein said second computer is further programmed to send the results of remote players' said performance analysis to said first computer upon completion of said performance analysis; wherein said second computer comprises said sports competition server and communicates with said first computers via said second communications link in a client-server mode or peer-to-peer through personal computer or laptop Firewalls.

7: The apparatus as recited in claim 3, wherein said sports competition server is programmed to establish connections amongst subscribing players at a plurality of remote locations via said second communications link.

8: The apparatus as recited in claim 1, wherein said second computer is further programmed to create a plurality of games; wherein said games comprise one or more of said first computers of opponents connected to said first computer; wherein each first computer comprises a network port for connecting to said network, a serial data port for receiving a serial data stream from a respective apparatus where each first computer is programmed to perform the following:
processing the digital data stream from said respective apparatus into game data having a format representing performance results and or scoring for said player; and
transmitting said game data of said player to said second computer that comprises said sports competition server; and
polling said second computer for receipt of game data or text messages from an opponent or players at a remote site.

9: The apparatus as recited in claim 2 or 4, wherein said first computer is further programmed to process data received from said second computer.

10: The apparatus as recited in claim 2 or 4, wherein said first computer further comprises:
a method of controlling the state of the game by suspending play of said first computer if it's not that player's turn to play as indicated by said second computer.

11: The apparatus as recited in claim 3 or 6, wherein said sports competition server or second computer is further programmed to broadcast data between players in each said game.

12: The apparatus as recited in claim 2, wherein said first computer is further programmed to process data from said second computer or sports competition server representing the sports performance of a competitor when the state of the game is the competitor's turn participating in said game.

13: The apparatus as recited in claim 2, wherein said first computer is further programmed to send text messages to said second computer, wherein said second computer broadcasts said text messages to players participating in said game.

14: The first computer as recited in claim 1, wherein said first computer contains programming routines to signal said competition server of the availability to play one or more remote said competitors and await communication from said competition server.

15: A computerized interactive sports apparatus as recited in claim 3 or 6, wherein the second computer, which comprises a sports competition server selects remote players from a queue of waiting players in response to a player's availability and readiness to play.

16: The computerized interactive sports network as in claim 3, wherein the second communications link comprises a peer-to-peer network connection or client-server network connection via the Internet.

17: A method for tracking and determining the differences between the original sports apparatus from a cloned sports apparatus as cited in claim 1 comprising:
a means for determining an original sports apparatus location;
a means for determining a cloned sports apparatus location;
a means for determining an original sports apparatus digital key location on the client side of the network;
a means for determining a cloned sports apparatus digital key location on the client side of the network;
a means for determining an original sports apparatus digital lock location on the server side of the network;
a means for determining a cloned sports apparatus digital lock location on the server side of the network providing a wireless sports apparatus with a global positioning system receiver, which enables determination of the location of the original sports apparatus;
a means for providing a wireless sports apparatus with a global positioning system receiver, which enables determination of the location of the cloned sports apparatus and transmitting the location of the wireless original sports apparatus to a computer within said network; and
transmitting the location of the wireless cloned sports apparatus to a remote computer within said network;
a means of determining the transmitted location if the original sports apparatus user is within a predetermined boundary of a player's location; and
determining from the transmitted location if the cloned sports apparatus is within a predetermined boundary of said player's location from said sports apparatus user; and
authorizing the operational use of the original sports apparatus only if the location is within a predetermined boundary of said player's address or location from said user of the original sports apparatus; and
determine if the position is within the predetermined boundary of said player's location from said user of the cloned sports apparatus; and
the global positioning system receiver storing the last locations detected and processing these locations regardless of whether they are current; and
ascertaining if the transmitted location of the original sports apparatus is not current and denying authorization of said player's ability to use said sports apparatus if their location is not current;
a plurality of sensors connected to a control system, a global positioning system receiver, a memory device, and a control system operative to perform the following functions:
receive signals from the global positioning system relating to geographical positioning of the user while engaged in a sports apparatus activity; and
store the geographical position information in a memory device; and
receive signals from a plurality of sensors and store quantity information in a memory device; and
interface between the wireless sports apparatus and a central processing unit enabling the computer to access the contents of memory storage devices and display the information as a function of the geographical position of the user while engaged in the sporting activity;
whereby each original sports apparatus has a unique digital code and each cloned sports apparatus has a unique code. The digital codes are comprised of two (2) elements, the key and lock. The digital keys are held on the client side of the network. The digital locks are held on the server side of the network. When the control system or micro-controller receives data from any of a plurality of sensors on the sports apparatus, a unique digital code identifies the original sports apparatus and its location is verified by a global positioning system signal updated by a particular motion or sporting activity. If the micro-controller receives data from any of a plurality of sensors on the cloned sports apparatus, it determines by a unique digital code if it's an original sports apparatus and its location is verified by a global positioning system signal updated according to a particular motion or sporting activity and authenticated to operate within a home or office location network.

18: A wireless pluggable module in accordance with claim 1, located inside a connector and said wireless pluggable module is adapted to provide a set of wireless signals that correspond to a predetermined frequency range emitted from said connector transmitting characteristics of said wireless pluggable module; wherein said wireless pluggable module protocol includes a means resident thereof for providing said set of wireless signals, and said means comprises:
a sports apparatus with a horizontal open bay section for easy insertion of said wireless pluggable to allow said wireless pluggable signals a means of transmitting to a receiver or communicating with a central processing unit;
a means for interchangeably mounting said sports apparatus so as to allow interchangeable use of wireless protocols with different sports apparatuses;
a means for maintaining proper take-up of the wireless pluggable module of said wireless connector while exiting said sports apparatus open bay section; and
a means of providing variable force biasing having a spring and CAM arrangement for placing the wireless connector under substantially constant tension during the take-up process;
a bursting means for separating said wireless connector when another wireless protocol is needed; and
an inserter means for attaching said wireless connector to the associated sports apparatus;
RFID pluggable module
Zigbee pluggable module
Bluetooth pluggable module
Wi-Fi pluggable module
Wi-Max pluggable module
UWB pluggable module
wherein, providing a method to insert or snap into place a wireless pluggable module into the open bay section of said sports apparatus, and said plurality of wireless protocols which will communicate with said first computer and said second computer in accordance with claim 1;
whereby, if a specific wireless protocol is no longer required it could be removed with a minimum amount of effort and replaced by another wireless pluggable module that operates on a different distinct frequency. These wireless pluggable modules include but are not limited to RFID, Zigbee, Bluetooth, Wi-Fi, Wi-Max, and UWB; wherein using this modular pluggable design allows the sports apparatus to be upgraded to include any future new wireless protocol. There are now a number of combination wireless protocols embedded in chip sets such as Bluetooth and Wi-Fi This enables the use of dual wireless pluggables such as Bluetooth and Wi-Fi combination chip sets.

19: A method of coordinating in accordance with claim 1, a plurality of a wireless transmission systems originating from various sports apparatus amongst a plurality of transmissions. The transmission medium is utilized in accordance with transmissions that are comprised of:
a broad spectrum of frequencies;
a multi-wireless chip set;
automatic stepping through a set of frequencies of said multi-wire chip sets
periodically checking for a specific frequency match amongst transmission means; and
identifying of each transmission means signature;
receiving data structures from transmission means;
communicating with a first computer;
communicating with a second computer,
whereby multiple wireless protocols are embedded in a chip set. The chip set is comprised of RFID, Zigbee, Bluetooth, Wi-Fi, Wi-Max, and UWB protocols; wherein, if a player swings a sports apparatus the system automatically detects which wireless protocol was used. This specific wireless protocol now becomes the dominant or active communications means and allows a network connection to be made locally via a local-area-network or routed to an Internet connection using a client-server or peer-to-peer network.

20: A physiological monitor in accordance with claim 1 comprising:
a wireless sensor based system for measuring respiration in real-time;
a wireless sensor based system for measuring heart rate in real-time;
a wireless sensor based system for measuring real-time brain wave activity;
an analog-to-digital converter with a digitized output signal converted into a serial data stream by a multiplexer to a computer located on the client side;
a method in accordance with claim 1, which further comprises generating and displaying on a sports apparatus client system a graphical representation of a respiration cycle that is animated based on real-time data that is received from the player using a monitoring device.
a method as recited in claim 1, which further comprises the steps of generating and displaying on the sports apparatus client system a graphical representation of a heart rate cycle that is animated based on real-time data that is received from the player using said monitoring device.
a method as recited in claim 1, which further comprises generating and displaying on the sports apparatus client system a graphical representation of brain wave cycles that is animated based on real-time data that is received from the player using said monitoring device.
a computer for storing and analyzing physiological activity during repetitive swings of a sporting device or object; and
synchronizing of physiological activity with swing motion via a sports apparatus whereby sensors are placed on various parts of the body, and data is gathered from the various sensors from each swing of said sports apparatus. The sensor data is converted from analog-to-digital format, read and processed by a central processing unit or first computer. The sensor data is then displayed on a monitor or stored in memory of said first computer for subsequent comparative analysis for training and motion improvement. The acquired sensor data can detect a player's calm state relative to what is clinically considered as normal, which translates to the player being more in control when using a sports apparatus.
